(19) United States
(12) Patent Application Publication
(10) Pub. No.: US 2026/0221000 A1
(43) Pub. Date: Jul. 30, 2026

(54) SKILL-BASED GAMING METHOD

(71) Applicant: John FOX, Bellevue, NE (US)

(72) Inventor: John FOX, Bellevue, NE (US)

(21) Appl. No.: 19/039,242

(22) Filed: Jan. 28, 2025

(51) Int. Cl. G07F 17/32

(52) U.S. Cl. CPC G07F 17/3244; G07F 17/3225; G07F 17/3237

(57) ABSTRACT

A method of conducting a game includes providing a network of gaming devices, and providing a central server that communicates with each gaming device. For each player, the method continues selecting a quantity of points per play by each player, and asking the player to join a prize party. If the player joins the prize party, the method continues with communicating with the central server of the network of gaming devices that that player has joined the prize party, increasing a prize party bonus by an amount in proportion to the quantity of points from the player, sending a prize party game to the player, wherein the player plays the prize party game, and awarding a proportionate amount of the prize party bonus to all winning players of the prize party. If the player does not join the prize party, the method continues with the steps of playing an individual game different from the prize game and crediting the player with a win amount when the individual game play is successful.

### BACKGROUND OF THE INVENTION

The present invention is directed to gaming systems. More particularly, the present invention is directed to a gaming method that provides for a player to engage in two games including a bonus game involving a plurality of other players.

A game of skill is a game, sometimes played on a machine whereby a result is derived substantially, predominantly or entirely by the player or participant's use of skills, as opposed to the result being controlled entirely by chance. In other words, it is a game where the players or participants rely on their skill to get to a final result and not upon chance. There are sometimes debates as to what constitutes a game of skill. A game of skill is a game where the outcome is determined mainly by mental and/or physical skill, rather than by pure chance.

It is generally agreed that skill games contain one or more, and in some cases all of the following:
1. a strategy to be applied;
2. the ability for the participant to improve;
3. an undefined or incalculable win rate; and
4. the player's skill or actions are the controlling factor in the game, rather than chance (this being the most widely accepted feature of a skill game).

Typically, the outcome of a play of the game must be controlled by the player playing the game and not by predetermined odds or random chance. Some chance may be part of the game, but skill must be the main feature.

Games of skill include many different types of games and come in many different forms and packages. They can be found in a wide variety of places and locations. Common examples of skill games include pool, darts, golf, trivia, and target shooting games. Such games can be found in taverns, arcades, grocery and retail stores, carnivals, festivals, and golf courses. Skill games often reward prizes and return something of value to the participants. These rewards are typically toys, stuffed animals, gift certificates, tokens, coins and currency, and an endless array of novelties and merchandise.

Games of skill can also be found in many different places in many different locations. There are also many activities where people are able to win prizes for participating in games and other events. A few examples of places where games of skill can be found and other games where prizes can be won include arcades, retail stores, carnivals and festivals, state and county fairs, specialty restaurants, theme parks, special promotions, tournaments and leagues, game shows, and sports and performance-based pay.

Coin operated games of skill can be found all around us. Arcades, hotels, retail stores, and restaurants all play host to such games of skill. Coin operated, and sometimes non-coin operated games of skill can be found among other places at carnivals, state fairs, and church or school festivals.

There are a vast array of means and methods to compete for and obtain prizes that have little or nothing to do with chance. A golf tournament, playing a Cyclone game, or selling cookies are just a few clear examples whereby prizes can be won.

Games of skill can take the form of electronic video games, more commonly seen in “gaming” type games. Additionally, on such electronic video screens, preview screens or views are known. Here, a preview of a field of game symbols is displayed before actual play. For example, U.S. Pat. No. 7,736,223 (Pace) is directed to an electronic gaming method with a preview display. A field of game symbols is presented on the display to the player as a preview for deciding whether or not to play the next game. In this particular variation, if the player decides to play the game, the player selects a field element to turn the symbol displayed into a wild symbol. The winning combinations of symbols are then displayed.

All references cited herein are incorporated herein by reference in their entireties.

### SUMMARY OF THE INVENTION

The present invention provides a method of playing a game-within-a-game (i.e., playing a game on a game terminal while another game is being played on the same terminal by the same player). This game-in-game is played by a plurality of game terminals simultaneously, where the game terminals are all linked together over a network, and to a central server. Each player initiates play on a respective gaming device, such as by pressing a play button. The player is then given an option to play the game-in-game.

The present invention is directed to a method of conducting a game. The method begins with step of providing a network of a plurality of gaming devices linked together. A central server is provided that communicates with each gaming device of the network of gaming devices. Each of a plurality of players is provided with one of the gaming devices of the plurality of gaming devices, wherein each gaming device has a display, and wherein each player is provided with a player account. For each player of the plurality of players, the player inputs a quantity of points into each game device from each player account. A quantity of points per play by each player is selected. The player is asked if he or she wants to join a prize party. If the player joins the prize party, the central server communicates with the network of gaming devices that that player has joined the prize party. A prize party bonus is incremented (i.e., increased) by an amount in proportion to the quantity of points from the player. The central server sends a prize party game to the player, wherein the player plays the prize party game. The method continues with the step of awarding a proportionate amount of the prize party bonus to all winning players of the prize party. Whether or not the player joins the prize party, the method continues with the steps of playing, by the player, an individual game different from the prize game and crediting the player with a win amount when the individual game play is successful.

The prize party game may be common to all players in the prize party. The prize party bonus value may be displayed to each player of the plurality of players. Each point may have a cash value. The prize party game may be a skill-based game. The individual game may also be a skill-based game.

### BRIEF DESCRIPTION OF THE DRAWINGS

FIG. 1 depicts a system schematic diagram of a network of gaming devices linked together by local location servers connected to a central server, in accordance with a game in accordance with the present invention.

FIG. 2 depicts a flowchart of a method of conducting a game in accordance with the present invention.

### DETAILED DESCRIPTION

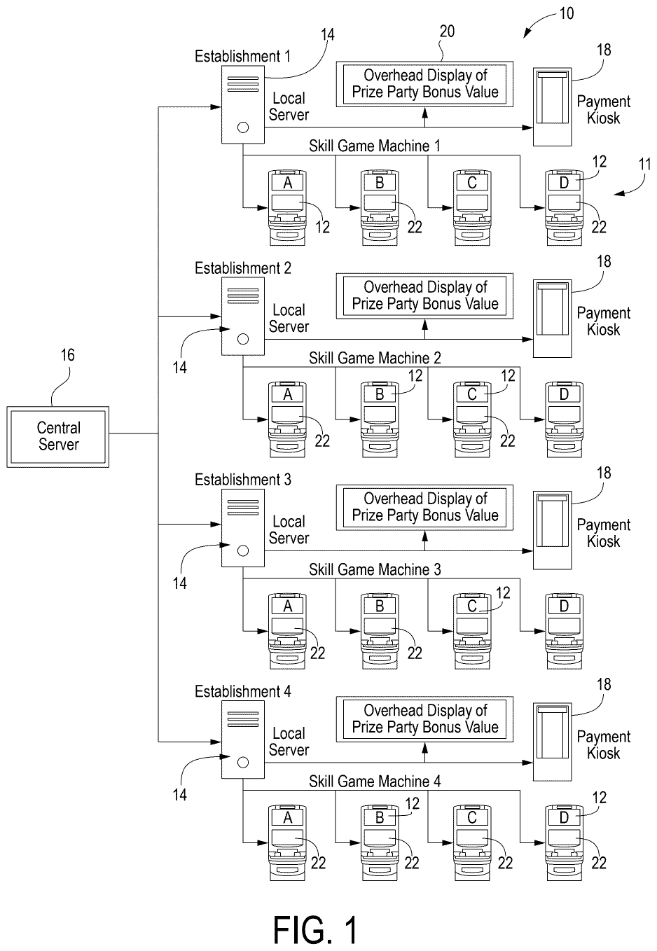

Referring now to the drawing figures wherein like reference numbers refer to like elements throughout the several views, there is shown in FIG. 1 a schematic diagram an overall system 10 related to a method of conducting a game in accordance with the present invention. The system 10 includes of a network 11 of gaming devices 12 linked together by local servers 14 that are all connected to a central server 16. Optionally, payment kiosks 18 are provided to assist in providing awards and inputting money for play, as are well known. Overhead displays 20 of prize party bonus values for different locations of play may be provided, as will be described in further detail below.

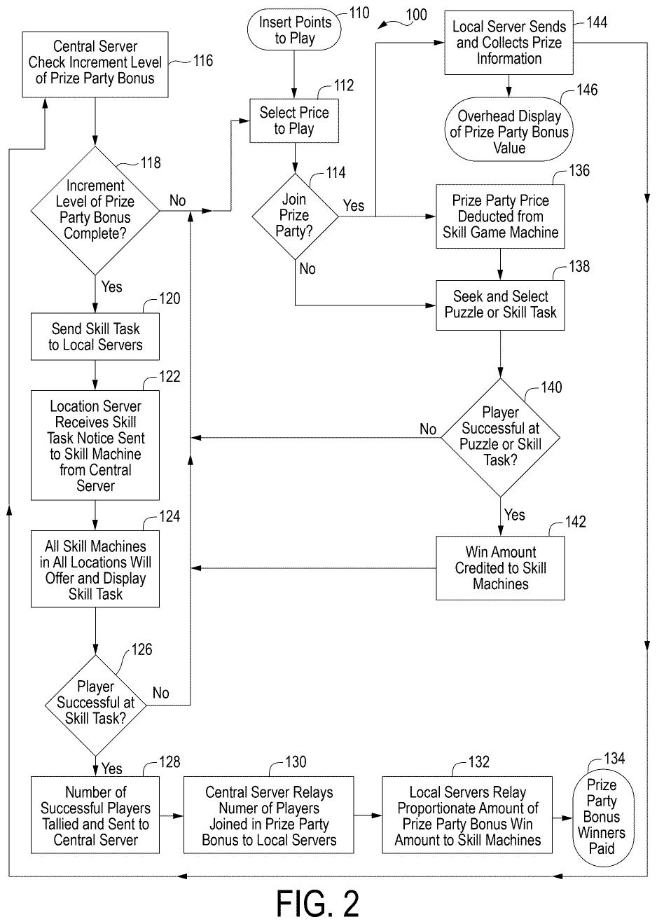

The method of conducting the game 100 is provided in the flowchart depicted in FIG. 2. The method of conducting the game 100 first the step of providing the network 11 of a plurality of gaming devices 12 linked together and providing the central server 16 that communicates with each gaming device 12 of the network 11 of gaming devices 12. Each of a plurality of players is provided with one of the gaming devices 12 of the plurality of gaming devices, wherein each gaming device 12 has a display 22, and wherein each player is provided with a player account.

For each player of the plurality of players, the player inputs a quantity of points (for example, cash, funds or the like) into each game device 12 from that player's player account. That player selects a quantity of points per play by each player. See step 112. The player is asked whether or not her or she wants to join a prize party. See step 114.

If the player elects to join the prize party, a local server communicates with the central server of the network of gaming devices that that player has joined the prize party. A prize party bonus is increased or increments by an amount in proportion to the quantity of points from the player. See step 116 Once all players have decided to join or decline to join, the prize party, the prize party bonus is deemed complete. See step 118. This may occur, for example, within a designated time period. The central server 16 sends a prize party game to the player (see Step 122) via, for example, the local server 114, wherein the player plays the prize party game. See step 124. The system 10 then determines whether the player is successful at the prize party game. See step 126. If the player is successful at the prize party game, the central server 16 tallies the number of successful players. See step 128 The central server 16 may then relay the number of successful players to the local servers and the local servers relay a proportionate amount of the prize party bonus to all winning players and the winners are paid. See steps 130, 132 and 134.

Whether or not the player joins the prize party, the method continues with the step of playing, by the player, an individual game different from the prize game. See step 138. The player selects a game, for example, an unsolved puzzle or skill task. When the player is successful at the individual game play, the player is credited with a win amount. Whether or not the player elected to join the prize party, after the individual game is completed, the method returns to step 112 where that player selects a quantity of points per play by each player. See steps 140 and 142.

The prize party game is preferably common to all players in the prize party. Preferably, the game is a puzzle or other skill-based game. The prize party bonus value may be collected at the local server. See step 144. The prize party bonus value may be displayed locally to each player of the plurality of players. See step 146.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method of conducting a game, comprising:
(a) providing a network comprising a plurality of gaming devices linked together;
(b) providing a central server that communicates with each gaming device of the network of gaming devices;
(c) wherein each of a plurality of players is provided with one of the gaming devices of the plurality of gaming devices, wherein each gaming device has a display, and wherein each player is provided with a player account;
(d) wherein for each player of the plurality of players, the method continues with the steps of:
(i) inputting a quantity of points into each game device from each player account, by each player;
(ii) selecting a quantity of points per play by each player; and
(iii) asking the player to join a prize party,
(A) if the player joins the prize party,
(1) communicating with the central server of the network of gaming devices that that player has joined the prize party;
(2) increasing a prize party bonus by an amount in proportion to the quantity of points from the player;
(3) sending, by the central server, a prize party game to the player, wherein the player plays the prize party game; and
(4) awarding a proportionate amount of the prize party bonus to all winning players of the prize party; and
(B) wherein, whether or not the player joins the prize party, the method continues with the steps of:
(1) playing, by the player, an individual game different from the prize game; and
(2) crediting the player with a win amount when the individual game play is successful.

2. The method of claim 1, wherein the prize party game is common to all players in the prize party.

3. The method of claim 1, wherein the prize party bonus value is displayed to each player of the plurality of players.

4. The method of claim 1, wherein each point has a cash value.

5. The method of claim 1, wherein the prize party game is a skill-based game.

6. The method of claim 1, wherein the individual game is a skill-based game.
